(19) United States
(12) Patent Application Publication
(10) Pub. No.: US 2022/0024472 A1
(43) Pub. Date: Jan. 27, 2022

(54) CONTROL APPARATUS FOR VEHICLE

(71) Applicant: TOYOTA JIDOSHA KABUSHIKI KAISHA, Toyota-shi (JP)

(72) Inventors: Isamu HACHISUWA, Nagoya-shi (JP); Atsushi Tabata, Okazaki-shi (JP); Koichi Okuda, Toyota-shi (JP); Masafumi Yamamoto, Nagakute-shi (JP); Yuuki Makino, Aichi-ken (JP)

(73) Assignee: TOYOTA JIDOSHA KABUSHIKI KAISHA, Toyota-shi (JP)

(21) Appl. No.: 17/369,357

(22) Filed: Jul. 7, 2021

(51) Int. Cl. B60W 50/04

(52) U.S. Cl. CPC B60W 50/045; B60W 2050/0088

(57) ABSTRACT

A control apparatus provided with first and second control devices, and configured to execute vehicle control and to execute update processing for updating a vehicle control software that is to be used for the vehicle control. The control apparatus includes: a first storage device included in the first control device and configured to store therein the vehicle control software; a second storage device included in the second control device and configured to store therein a new software to which the vehicle control software is to be updated; an update processing portion configured to execute the update processing for updating the vehicle control software by writing the new software stored in the second storage device, into the first storage device; and a backup processing portion configured, prior to the update processing by the update processing portion, to write the vehicle control software into the second storage device.

This application claims priority from Japanese Patent Application No. 2020-126887 filed on Jul. 27, 2020, the disclosure of which is herein incorporated by reference in its entirety.

### FIELD OF THE INVENTION

The present invention relates to a control apparatus for controlling a vehicle.

### BACKGROUND OF THE INVENTION

There is well-known a control apparatus provided with first and second control devices, and configured to execute vehicle control for controlling a vehicle and to execute update processing for updating a vehicle control software that is to be used for the vehicle control. An example of such a control apparatus is disclosed in JP2016-118879A. This Japanese Patent Application Publication discloses a communication control device and a program control device that includes first and second memory regions. The program control device is configured to execute normal control by starting a control program stored in the first memory region, and is configured to rewrite the control program stored in the first memory region, to a new program, when receiving a rewriting request through the communication control device. When the new program is to be written into the first memory region, the program control device transfers the control program from the first memory region to the second memory region such that the control program is stored in the second memory region before the new program is written into the first memory region.

### SUMMARY OF THE INVENTION

By the way, in view of the above-identified Japanese Patent Application Publication, it might be possible to provide, in addition to a first storage device in a first control device, another storage device in the first control device, and to cause the vehicle control software to be backed up in the other storage device provided in the first storage device, prior to execution of the update processing. In this arrangement, in a case in which the update processing cannot be successfully completed, namely, in a case in which the vehicle control software cannot be successfully updated to a new software, the vehicle control software backed up in the other storage device can be written back into the first storage device, so that the vehicle can be controlled by using the vehicle control software written back into the first storage device. However, in this arrangement, the first control device needs to be provided with a storage device having a large capacity as a whole.

The present invention was made in view of the background art described above. It is therefore an object of the present invention to provide a vehicle control apparatus capable of controlling a vehicle by reviving a current vehicle control software in the event of failure in update processing for updating the current vehicle control software while suppressing enlargement of a capacity of a storage device as a whole of a first control device.

The object indicated above is achieved according to the following aspects of the present invention.

According to a first aspect of the invention, there is provided a control apparatus provided with first and second control devices, and configured to execute vehicle control for controlling a vehicle and to execute update processing for updating a vehicle control software that is to be used for the vehicle control. The control apparatus includes: (a) a first storage device included in the first control device and configured to store therein the vehicle control software; (b) a second storage device included in the second control device and configured to store therein a new software to which the vehicle control software is to be updated; (c) a vehicle-control execution portion configured to execute the vehicle control by using the vehicle control software; (d) an update processing portion configured to execute the update processing for updating the vehicle control software by writing the new software stored in the second storage device, into the first storage device; and (e) a backup processing portion configured, prior to the update processing by the update processing portion, to write the vehicle control software stored in the first storage device, into the second storage device. It is noted that above-described new software, which may be referred to as “new version of the vehicle control software”, is a software to which the vehicle control software is to be updated by execution of the update processing, namely, is a software by which the vehicle control software is to be replaced by the execution of the update processing, wherein the new software may be either partially or entirely different in content from vehicle control software.

According to a second aspect of the invention, in the control apparatus according to the first aspect of the invention, the backup processing portion is configured, when the update processing has not been successfully executed by the update processing portion, to write the vehicle control software written into the second storage device, into the first storage device.

According to a third aspect of the invention, in the control apparatus according to the first or second aspect of the invention, the backup processing portion is configured, when the update processing has been successfully executed by the update processing portion, to erase the vehicle control software written into the second storage device, from the second storage device.

According to a fourth aspect of the invention, in the control apparatus according to any one of the first through third aspects of the invention, there is further provided a reception processing portion configured, when the second storage device is to store therein another new software other than the new software that has been already written into the second storage device and stored in the second storage device, to calculate an estimated free space left in the second storage device in a state in which the vehicle control software has been written into the second storage device by the backup processing portion prior to execution of the update processing by the update processing portion, wherein the reception processing portion is configured, when the estimated free space is smaller than a space required to write the other new software into the second storage device, to inhibit the other new software from being written into the second storage device.

According to a fifth aspect of the invention, in the control apparatus according to any one of the first through fourth aspects of the invention, the update processing portion is configured to execute the update processing when the vehicle-control execution portion does not execute the vehicle control by using the vehicle control software that is to be updated to the new software.

In the control apparatus according to the first aspect of the invention, prior to execution of the update processing for updating the vehicle control software stored in the first storage device of the first control device by writing the new software stored in the second storage device of the second control device, into the first storage device, the vehicle control software subjected to the update processing is written into the second storage device, so that, when the writing of the new software is not successfully completed, namely, when the writing of the new software results in failure, it is possible to write the current vehicle control software subjected to the update processing and backed up in the second storage device, back into the first storage device. Therefore, it is possible to control the vehicle by reviving the current vehicle control software in the event of failure in the update processing for updating the current vehicle control software while suppressing enlargement of a capacity of the storage device as a whole of the first control device.

In the control apparatus according to the second aspect of the invention, when the update processing of the vehicle control software stored in the first storage device has not been successfully executed, the vehicle control software subjected to the update processing and written into the second storage device prior to execution of the update processing, is written back into the first storage device. Therefore, it is possible to control the vehicle by using the current vehicle control software in the event of failure in the update processing for updating the current vehicle control software.

In the control apparatus according to the third aspect of the invention, when the update processing of the vehicle control software stored in the first storage device has been successfully executed, the vehicle control software subjected to the update processing and written into the second storage device prior to execution of the update processing, is erased from the second storage device. Thus, after the update processing of the vehicle control software has been successfully executed, the backed-up vehicle control software is not kept stored in the second storage device, so that it is possible to appropriately ensure a free space of the second storage device.

In the control apparatus according to the fourth aspect of the invention, when the other new software other than the new software that has been already written into the second storage device is to be stored in the second storage device, the estimated free space left in the second storage device in the state in which the vehicle control software would have been written into the second storage device prior to execution of the update processing, is calculated. Then, when the estimated free space is smaller than the space required to write the other new software into the second storage device, the other new software is inhibited from being written into the second storage device, so that it is possible to avoid a situation in which the vehicle control software cannot be backed up in the second storage device when the update processing using the already written new software is to be executed.

In the control apparatus according to the fifth aspect of the invention, the update processing is executed when the vehicle control by using the vehicle control software that is to be updated to the new software is not being executed, so that it is possible to prevent problem from being caused in execution of the vehicle control, due to execution of the update processing of the vehicle control software.

### BRIEF DESCRIPTION OF THE DRAWINGS

FIG. 1 is a view schematically showing a construction of a vehicle to which the present invention is applied, for explaining a control apparatus for the vehicle;

FIG. 2 is a table indicating a relationship between each gear position of a mechanically-operated step-variable transmission portion (shown in FIG. 1) and a combination of engagement devices of the step-variable transmission portion, which are placed in engaged states to establish the gear position in the step-variable transmission portion;

FIG. 3 is a collinear chart indicating a relationship among rotational speeds of rotary elements of an electrically-operated continuously-variable transmission portion (also shown in FIG. 1) and the mechanically-operated step-variable transmission portion;

FIG. 4 is a view showing, by way of example, an arrangement in which a vehicle control software is updated through a wireless communication;

FIG. 5 is a view showing, by way of examples, an AT-gear-position shifting map used for controlling gear shifting in the step-variable transmission portion (shown in FIG. 1), a drive-power-source switching map used for switching a running mode of the vehicle, and a relationship between the shifting map and the drive-power-source switching map;

FIG. 6 is a view showing, by way of example, a case in which a new software is stored in a second storage device and writing of another new software into the second storage device is requested, wherein the writing of the other new software is allowed;

FIG. 7 is a view showing, by way of another example (that is other than the example shown in FIG. 6), a case in which the new software is stored in the second storage device and writing of the other new software into the second storage device is requested, wherein the writing of the other new software is inhibited; and

FIG. 8 is a flow chart showing a main part of a control routine executed by a vehicle control apparatus, namely, a control routine that is executed for making it possible to control the vehicle by reviving the current vehicle control software in the event of failure in update processing for updating the current vehicle control software while suppressing enlargement of a capacity of a storage device as a whole of an electronic control device of the vehicle control apparatus.

### DETAILED DESCRIPTION OF PREFERRED EMBODIMENT

In the embodiment of the present invention, a gear ratio in a vehicle transmission is defined as “rotational speed of input-side rotary member/rotational speed of output-side rotary member”. A running speed of the vehicle could be lower as the gear ratio is higher, and could be higher as the gear ratio is lower. The highest gear ratio can be expressed also as a lowest-speed gear ratio.

Hereinafter, the preferred embodiment of the invention will be described in detail with reference to the accompanying drawings.

### EMBODIMENT

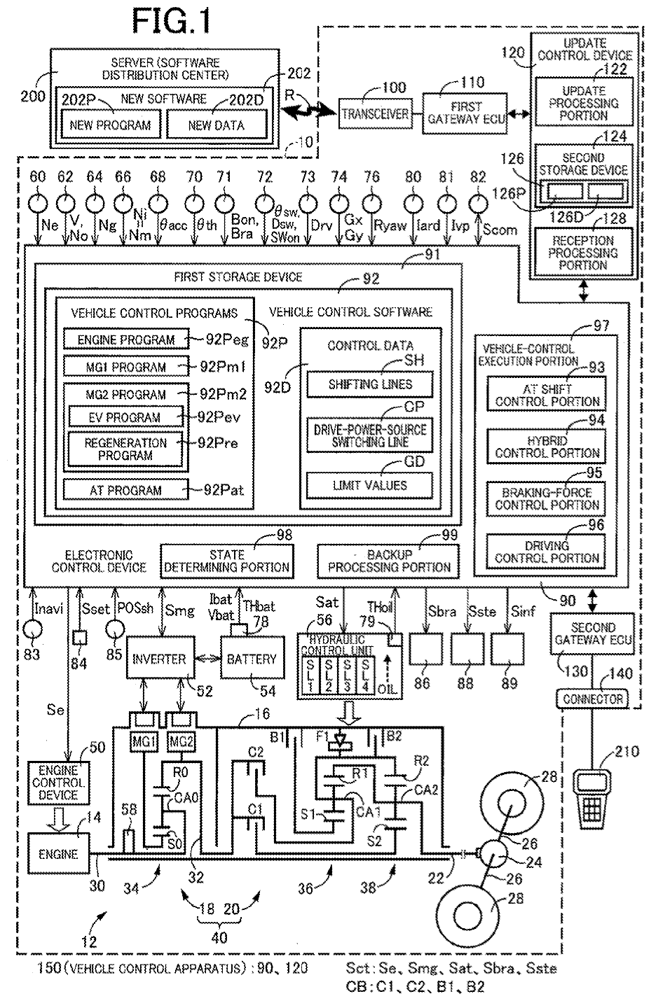

FIG. 1 is a view schematically showing a construction of a vehicle 10 to which the present invention is applied, for explaining major portions of control functions and control systems that are provided to perform various control operations in the vehicle 10. As shown in FIG. 1, the vehicle 10 includes a power transmission apparatus 12, an engine 14 and first and second rotating machines MG1, MG2.

The engine 14 is a known internal combustion engine such as gasoline engine and diesel engine, which serves as a drive power source capable of generating a drive power. The vehicle 10 is provided with an engine control device 50 that includes a throttle actuator, a fuel injection device and an ignition device. With the engine control device 50 being controlled by an electronic control device 90 that is described below, an engine torque Te, which is an output torque of the engine 14, is controlled.

Each of the first and second rotating machines MG1, MG2 is a rotating electric machine having a function serving as an electric motor and a function serving as a generator. That is, each of the first and second rotating machines MG1, MG2 is a so-called “motor generator”. The first and second rotating machines MG1, MG2 are connected to a battery 54 provided in the vehicle 10, through an inverter 52 provided in the vehicle 10. The inverter 52 is controlled by the electronic control device 90 whereby an MG1 torque Tg and an MG2 torque Tm as output torques of the respective first and second rotating machines MG1, MG2 are controlled. The output torque of each of the first and second rotating machines MG1, MG2 serves as a power running torque when acting as a positive torque for acceleration, with the each of the first and second rotating machines MG1, MG2 being rotated in a forward direction that is the same as a direction of rotation of the engine 14 during operation of the engine 14. The output torque of each of the first and second rotating machines MG1, MG2 serves as a regenerative torque when acting as a negative torque for deceleration, with the each of the first and second rotating machines MG1, MG2 being rotated in the forward direction. The battery 54 is an electric storage device to and from which an electric power is supplied from and to the first rotating machine MG1 and the second rotating machine MG2. The first and second rotating machines MG1, MG2 are disposed inside a casing 16 that is a non-rotary member that is attached to a body of the vehicle 10.

The power transmission apparatus 12 includes, in addition to the casing 16, an electrically-operated continuously-variable transmission portion 18 and a mechanically-operated step-variable transmission portion 20. The continuously-variable transmission portion 18 and the step-variable transmission portion 20 are provided within the casing 16, and are arranged in a series on a common axis. The continuously-variable transmission portion 18 is connected to the engine 14 directly or indirectly through, for example, a damper (not shown). The step-variable transmission portion 20 is connected to an output rotary member of the continuously-variable transmission portion 18. The power transmission apparatus 12 further includes a differential gear device 24 connected to an output shaft 22 that is an output rotary member of the step-variable transmission portion 20, and a pair of axles 26 connected to the differential gear device 24. The axles 26 are connected to drive wheels 28 of the vehicle 10. It is noted that the power transmission apparatus 12 including the continuously-variable transmission portion 18 and the step-variable transmission portion 20 is constructed substantially symmetrically about its axis corresponding to the above-described common axis, so that a lower half of the power transmission apparatus 12 is not shown in FIG. 1. The above-described common axis corresponds to axes of a crank shaft of the engine 14 and a connection shaft 30 that is an input rotary member of the continuously-variable transmission portion 18 connected to the crank shaft.

The continuously-variable transmission portion 18 is provided with: the above-described first rotating machine MG1; and a differential mechanism 34 serving as a drive-power distributing device to mechanically distribute the drive power of the engine 14 to the first rotating machine MG1 and to an intermediate transmission member 32 that is an output rotary member of the continuously-variable transmission portion 18. To the intermediate transmission member 32, the above-described second rotating machine MG2 is connected in a drive-power transmittable manner. The continuously-variable transmission portion 18 is an electrically-operated continuously-variable transmission wherein a differential state of the differential mechanism 34 is controllable by controlling an operation state of the first rotating machine MG1. The continuously-variable transmission portion 18 is operated as the electrically-operated continuously-variable transmission whose gear ratio (that is referred also to as “speed ratio”) γ0 (=engine rotational speed Ne/MG2 rotational speed Nm) is changeable. The engine rotational speed Ne is a rotational speed of the engine 14, and is equal to an input rotational speed of the continuously-variable transmission portion 18, i.e., a rotational speed of the connection shaft 30. The MG2 rotational speed Nm is a rotational speed of the second rotating machine MG2, and is equal to an output rotational speed of the continuously-variable transmission portion 18, i.e., a rotational speed of the intermediate transmission member 32. The first rotating machine MG1 is a rotating machine capable of controlling the engine rotational speed Ne, and corresponds to a differential rotating machine. It is noted that controlling the operation state of the first rotating machine MG1 is controlling an operation of the first rotating machine MG1.

The differential mechanism 34 is a planetary gear device of a single-pinion type having a sun gear S0, a carrier CA0 and a ring gear R0. The carrier CA0 is connected to the engine 14 through the connection shaft 30 in a drive-power transmittable manner, and the sun gear S0 is connected to the first rotating machine MG1 in a drive-power transmittable manner, while the ring gear R0 is connected to the second rotating machine MG2 in a drive-power transmittable manner. In the differential mechanism 34, the carrier CA0 serves as an input element, and the sun gear S0 serves as a reaction element, while the ring gear R0 serves as an output element.

The step-variable transmission portion 20 is a mechanically-operated transmission mechanism as a step-variable transmission which constitutes a part of a drive-power transmission path between the intermediate transmission member 32 and the drive wheels 28, namely, constitutes a part of a drive-power transmission path between the continuously-variable transmission portion 18 and the drive wheels 28. The intermediate transmission member 32 also serves as an input rotary member of the step-variable transmission portion 20, and is connected to the second rotating machine MG2 so as to be rotatable integrally with the second rotating machine MG2. The second rotating machine MG2 is a rotating machine serving as a drive power source capable of generating a drive power, and corresponds to a rotating machine for driving the vehicle 10. Further, the engine 14 is connected to an input rotary member of the continuously-variable transmission portion 18, so that the step-variable transmission portion 20 is considered to also as a vehicle transmission constituting a part of a drive-power transmission path between the drive power source (second rotating machine MG2 or engine 14) and the drive wheels 28. The step-variable transmission portion 20 is a known automatic transmission of a planetary gear type which is provided with a plurality of planetary gear devices in the form of a first planetary gear device 36 and a second planetary gear device 38, and a plurality of engagement devices including a one-way clutch F1, a clutch C1, a clutch C2, a brake B1 and a brake B2. Hereinafter, the clutch C1, clutch C2, brake B1 and brake B2 will be referred to as engagement devices CB unless they are to be distinguished from each other.

Each of the engagement devices CB is a hydraulically-operated frictional engagement device in the form of a multiple-disc type or a single-disc type clutch or brake that is to be pressed by a hydraulic actuator, or a band brake that is to be tightened by a hydraulic actuator. A torque capacity of each of the engagement devices CB is to be changed by an engaging pressure in the form of a corresponding one of hydraulic pressures as regulated pressures supplied from solenoid valves SL1-SL4, for example, of a hydraulic control unit (hydraulic control circuit) 56 provided in the vehicle 10, whereby an operation state of each of the engagement devices CB is to be switched among engaged, slipped and released states, for example.

In the step-variable transmission portion 20, selected ones of rotary elements of the first and second planetary gear devices 36, 38 are connected to each other or to the intermediate transmission member 32, casing 16 or output shaft 22, either directly or indirectly through the engagement devices CB or the one-way clutch F1. The rotary elements of the first planetary gear device 36 are a sun gear S1, a carrier CA1 and a ring gear R1. The rotary elements of the second planetary gear device 38 are a sun gear S2, a carrier CA2 and a ring gear R2.

The step-variable transmission portion 20 is shifted to a selected one of a plurality of gear positions (speed positions) by engaging actions of selected ones of the engagement devices CB. The plurality of gear positions have respective different gear ratios (speed ratios) γat (=AT input rotational speed Ni/output rotational speed No). Namely, the step-variable transmission portion 20 is shifted up and down from one gear position to another by placing selected ones of the engagement devices in the engaged state. In the following description of the present embodiment, the gear position established in the step-variable transmission portion 20 will be referred to as an AT gear position. The AT input rotational speed Ni is an input rotational speed of the step-variable transmission portion 20 that is a rotational speed of the input rotary member of the step-variable transmission portion 20, which is equal to the rotational speed of the intermediate transmission member 32, and which is equal to the MG2 rotational speed Nm that is the rotational speed of the second rotating machine MG2. Thus, the AT input rotational speed Ni can be represented by the MG2 rotational speed Nm. The output rotational speed No is a rotational speed of the output shaft 22 that is an output rotational speed of the step-variable transmission portion 20, which is considered to be an output speed of a transmission device (composite transmission) 40 which consists of the continuously-variable transmission portion 18 and the step-variable transmission portion 20. It is noted that the engine rotational speed Ne corresponds to also an input rotational speed of the transmission device 40.

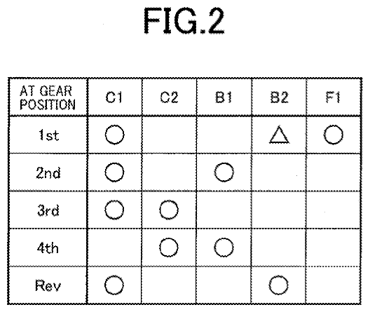

As shown in a table of FIG. 2, the step-variable transmission portion 20 is configured to establish a selected one of a plurality of AT gear positions in the form of four forward AT gear positions and a reverse AT gear position. The four forward AT gear positions consist of a first speed AT gear position, a second speed AT gear position, a third speed AT gear position and a fourth speed AT gear position, which are represented by “1st”, “2nd”, “3rd” and “4th” in the table of FIG. 2. The first speed AT gear position is the lowest-speed gear position having a highest gear ratio γat, while the fourth speed AT gear position is the highest-speed gear position having a lowest gear ratio γat. The gear ratio γat decreases in a direction from the first speed AT gear position (lowest-speed gear position) toward the fourth speed AT gear position (highest-speed gear position). The reverse AT gear position is represented by “Rev” in the table of FIG. 2, and is established by, for example, engagements of the clutch C1 and the brake B2. That is, when the vehicle 10 is to run in reverse direction, the first speed AT gear position is established, for example. The table of FIG. 2 indicates a relationship between each of the AT gear positions of the step-variable transmission portion 20 and operation states of the respective engagement devices CB of the step-variable transmission portion 20, namely, a relationship between each of the AT gear positions and a combination of ones of the engagement devices CB, which are to be placed in theirs engaged states to establish the each of the AT gear positions. In the table of FIG. 2, “O” indicates the engaged state of the engagement devices CB, “A” indicates the engaged state of the brake B2 during application of an engine brake to the vehicle 10 or during a coasting shift-down action of the step-variable transmission portion 20, and the blank indicates the released state of the engagement devices CB.

The step-variable transmission portion 20 is configured to switch from one of the AT gear positions to another one of the AT gear positions, namely, to establish one of the AT gear positions which is selected, by the electronic control device 90, according to, for example, an accelerating operation made by a vehicle driver (operator) and a vehicle running speed V. The step-variable transmission portion 20 is shifted up or down from one of the AT gear positions to another, for example, by so-called “clutch-to-clutch” shifting operation that is made by releasing and engaging actions of selected two of the engagement devices CB, namely, by a releasing action of one of the engagement devices CB and an engaging action of another one of the engagement devices CB.

The vehicle 10 further includes an MOP 58 that is a mechanically-operated oil pump and also an electrically-operated oil pump (not shown). The MOP 58 is connected to the connection shaft 30, and is to be rotated together with rotation of the engine 14, so as to output a working fluid OIL that is to be used in the power transmission apparatus 12. The electrically-operated oil pump is to driven to output the working fluid OIL, for example, when the engine 14 is stopped, namely, when the MOP 58 is not driven. The working fluid OIL outputted by the MOP 58 and the electrically-operated oil pump is supplied to the hydraulic control unit 56, such that the working fluid OIL is regulated to the engaging pressure by the hydraulic control unit 56, and the operation state of each of the engagement devices CB is switched by the engaging pressure.

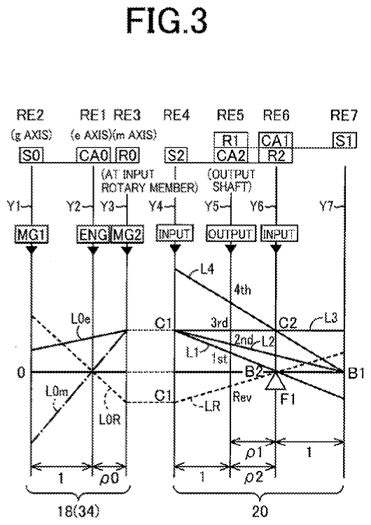

FIG. 3 is a collinear chart representative of a relative relationship of rotational speeds of the rotary elements in the continuously-variable transmission portion 18 and the step-variable transmission portion 20. In FIG. 3, three vertical lines Y1, Y2, Y3 corresponding to the three rotary elements of the differential mechanism 34 constituting the continuously-variable transmission portion 18 are a g-axis representative of the rotational speed of the sun gear S0 corresponding to a second rotary element RE2, an e-axis representative of the rotational speed of the carrier CA0 corresponding to a first rotary element RE1, and an m-axis representative of the rotational speed of the ring gear R0 corresponding to a third rotary element RE3 (i.e., the input rotational speed of the step-variable transmission portion 20) in order from the left side. Four vertical lines Y4, Y5, Y6, Y7 of the step-variable transmission portion 20 are axes respectively representative of the rotational speed of the sun gear S2 corresponding to a fourth rotary element RE4, the rotational speed of the ring gear R1 and the carrier CA2 connected to each other and corresponding to a fifth rotary element RE5 (i.e., the rotational speed of the output shaft 22), the rotational speed of the carrier CA1 and the ring gear R2 connected to each other and corresponding to a sixth rotary element RE6, and the rotational speed of the sun gear S1 corresponding to a seventh rotary element RE7 in order from the left. An interval between the vertical lines Y1, Y2, Y3 is determined in accordance with a gear ratio ρ0 of the differential mechanism 34. An interval between the vertical lines Y4, Y5, Y6, Y7 is determined in accordance with gear ratios ρ1, ρ2 of the first and second planetary gear devices 36, 38. When an interval between the sun gear and the carrier is set to an interval corresponding to “1” in the relationship between the vertical axes of the collinear chart, an interval corresponding to the gear ratio ρ (=the number of teeth of the sun gear/the number of teeth of the ring gear) of the planetary gear device is set between the carrier and the ring gear.

In representation using the collinear chart of FIG. 3, in the differential mechanism 34 of the continuously-variable transmission portion 18, the engine 14 (see “ENG” in FIG. 3) is connected to the first rotary element RE1, the first rotating machine MG1 (see “MG1” in FIG. 3) is connected to the second rotary element RE2, the second rotating machine MG2 (see “MG2” in FIG. 3) is connected to the third rotary element RE3 that is to be rotated integrally with the intermediate transmission member 32, and therefore, the rotation of the engine 14 is transmitted via the intermediate transmission member 32 to the step-variable transmission portion 20. In the continuously-variable transmission portion 18, the relationship between the rotational speed of the sun gear S0 and the rotational speed of the ring gear R0 is indicated by straight lines L0e, L0m and L0R crossing the vertical line Y2.

In the step-variable transmission portion 20, the fourth rotary element RE4 is selectively connected through the clutch C1 to the intermediate transmission member 32; the fifth rotary element RE5 is connected to the output shaft 22; the sixth rotary element RE6 is selectively connected through the clutch C2 to the intermediate transmission member 32 and selectively connected through the brake B2 to the casing 16; and the seventh rotary element RE7 is selectively connected through the brake B1 to the casing 16. In the step-variable transmission portion 20, the rotational speeds of “1st”, “2nd”, “3rd”, “4th”, and “Rev” of the output shaft 22 are indicated by respective straight lines L1, L2, L3, L4, LR crossing the vertical line Y5 in accordance with engagement/release control of the engagement devices CB.

The straight line L0e and the straight lines L1, L2, L3, L4 indicated by solid lines in FIG. 3 indicate relative speeds of the rotary elements during forward running in an HV running mode enabling an HV running (hybrid running) in which at least the engine 14 is used as the drive power source for driving the vehicle 10. The HV running is an engine running in which at least the drive power of the engine 14 is used for driving the vehicle 10. In this HV running mode, when a reaction torque, i.e., a negative torque from the first rotating machine MG1, is inputted in positive rotation to the sun gear S0 with respect to the engine torque Te inputted to the carrier CA0 in the differential mechanism 34, an engine direct transmission torque Td [=Te/(1+ρ0)=−(1/ρ0)×Tg] appears in the ring gear R0 as a positive torque in positive rotation. A combined torque of the engine direct transmission torque Td and the MG2 torque Tm is transmitted as a drive torque of the vehicle 10 in the forward direction depending on a required drive force to the drive wheels 28 through the step-variable transmission portion 20 having any AT gear position formed out of the first to fourth speed AT gear positions. In this case, the first rotating machine MG1 functions as an electric generator generating the negative torque in positive rotation. A generated electric power Wg of the first rotating machine MG1 is stored in the battery 54 or consumed by the second rotating machine MG2. The second rotating machine MG2 outputs the MG2 torque Tm by using all or a part of the generated electric power Wg or using the electric power from the battery 54 in addition to the generated electric power Wg. Thus, the first rotating machine MG1 is a rotating machine configured to output the reaction torque acting against the engine torque Te, for thereby causing the drive power of the engine 14 to be transmitted.

The straight line L0m indicated by one-dot chain line and the straight lines L1, L2, L3, L4 indicated by solid lines in FIG. 3 indicate the relative speeds of the rotary elements during forward running in an EV running mode enabling an EV running (motor running) in which the second rotating machine MG2 is used as the drive power source for driving the vehicle 10 with operation of the engine 14 being stopped. The EV running is a motor running in which only the drive power of the second rotating machine MG2 is used for driving the vehicle 10. During the forward running in the EV running mode, the carrier CA0 is not rotated while the MG2 torque Tm is inputted to the ring gear R0 in positive rotation so as to act as the positive torque. In this instance, the first rotating machine MG1 connected to the sun gear S0 is placed in a non-load state and freely rotatable in negative direction. Namely, during the forward running in the EV running mode, the engine 14 is not driven, so that the engine rotational speed Ne is kept zero, and the MG2 torque Tm is transmitted as a forward drive torque to the drive wheels 28 through the step-variable transmission portion 20 placed in one of the first through fourth speed AT gear positions. During this forward running in the EV running mode, the MG2 torque Tm is a power running torque that is a positive torque in positive rotation.

The straight lines L0R and LR indicated by broken lines in FIG. 3 indicate the relative speeds of the rotary elements during reverse running in the EV running mode. During the reverse running in this EV running mode, the MG2 torque Tm is inputted to the ring gear R0 in negative rotation so as to act as the negative torque, and the MG2 torque Tm is transmitted as the drive torque acting on the vehicle 10 in a reverse direction to the drive wheels 28 through the step-variable transmission portion 20 in which the first speed AT gear position is established. The vehicle 10 can perform the reverse running when the electronic control device 90 causes the second rotating machine MG2 to output a reverse MG2 torque Tm having a positive/negative sign opposite to a forward MG2 torque Tm outputted during forward running while a forward low-side AT gear position such as the first speed AT gear position is established as one the plurality of AT gear positions. During the reverse running in the EV running mode, the MG2 torque Tm is a power running torque that is a negative torque in negative rotation. It is noted that, even in the HV running mode, the reverse running can be performed as in the EV running mode, since the second rotating machine MG2 can be rotated in negative direction as indicated by the straight line L0R.

The vehicle 10 is a hybrid vehicle having the engine 14 and the second rotating machine MG2 as the drive power sources for driving the vehicle 10. In the power transmission apparatus 12, the drive power outputted from the engine 14 or the second rotating machine MG2 is transmitted to the step-variable transmission portion 20, and is then transmitted from the step-variable transmission portion 20 to the drive wheels 28, for example, through the differential gear device 24. Thus, the power transmission apparatus 12 is configured to transmit the drive power of the drive power sources in the form of the engine 14 and the second rotating machine MG2, to the drive wheels 28. It is noted that the power corresponds to a torque or a force unless otherwise distinguished from them.

Referring back to FIG. 1, the vehicle 10 is provided with the electronic control device 90 as a controller including the control apparatus which is constructed according to present invention and which is configured to control, for example, the engine 14, continuously-variable transmission portion 18 and step-variable transmission portion 20. FIG. 1 is a view showing an input/output system of the electronic control device 90, and is a functional block diagram for explaining major control functions and control portions if the electronic control device 90. For example, the electronic control device 90 includes a so-called microcomputer incorporating a CPU, a ROM, a RAM and an input-output interface. The CPU performs control operations of the vehicle 10, by processing various input signals, according to control programs stored in the ROM, while utilizing a temporary data storage function of the RAM. The electronic control device 90 may be constituted by two or more control units exclusively assigned to perform respective control operations such as a control operation for controlling the drive power sources and a control operation for controlling the step-variable transmission.

The electronic control device 90 receives various input signals based on values detected by respective sensors provided in the vehicle 10. Specifically, the electronic control device 90 receives: an output signal of an engine speed sensor 60 indicative of the engine rotational speed Ne; an output signal of an output speed sensor 62 indicative of the output rotational speed No which is the rotational speed of the output shaft 22 and corresponds to the running speed V of the vehicle 10; an output signal of a MG1 speed sensor 64 indicative of an MG1 rotational speed Ng which is a rotational speed of the first rotating machine MG1; an output signal of a MG2 speed sensor 66 indicative of the MG2 rotational speed Nm which is the rotational speed of the second rotating machine MG2 and which corresponds to the AT input rotational speed Ni; an output signal of an accelerator-opening degree sensor 68 indicative of an accelerator opening degree θacc representing an amount of accelerating operation made by the vehicle driver; an output signal of a throttle-valve-opening degree sensor 70 indicative of a throttle opening degree θth; an output signal of a brake pedal sensor 71 indicative of a brake-ON signal Bon representing a state of depression of a brake pedal by the vehicle driver to operate wheel brakes and also a braking operation amount Bra representing an amount of depression of the brake pedal by the vehicle driver; an output signal of a steering sensor 72 indicative of a steering angle θsw and a steering direction Dsw of a steering wheel provided in the vehicle 10 and also a steering ON signal SWon representing a state in which the steering wheel is being held by the vehicle driver; an output signal of a driver condition sensor 73 indicative of a driver condition signal Dry representing a condition of the vehicle driver; an output signal of a G sensor 74 indicative of a longitudinal acceleration Gx and a lateral acceleration Gy of the vehicle 10; an output signal of a yaw rate sensor 76 indicative of a yaw rate Ryaw that is an angular speed around a vertical axis of the vehicle 10; an output signal of a battery sensor 78 indicative of a battery temperature THba, a charging/discharging electric current Ibat and a voltage Vbat of the battery 54; an output signal of a fluid temperature sensor 79 indicative of a working fluid temperature THoil that is a temperature of the working fluid OIL; an output signal of a vehicle-area information sensor 80 indicative of vehicle area information lard; an output signal of a vehicle location sensor 81 indicative of location information Ivp; an output signal of an external-network communication antenna 82 indicative of an communication signal Scom; an output signal of a navigation system 83 indicative of navigation information Inavi; output signals of drive-assist setting switches 84 indicative of drive-assist setting signals Sset representing a setting made by the vehicle driver for execution of a drive-assist control such as automatic drive control and a cruise control; and an output signal of a shift position sensor 85 indicative of an operation position POSsh of a shift lever provided in the vehicle 10.

The amount of the accelerating operation made by the vehicle driver is, for example, an amount of operation of an acceleration operating member such as an accelerator pedal, and corresponds to a required output amount that is an amount of output of the vehicle 10 required by the vehicle driver. As the required output amount required by the vehicle driver, the throttle opening degree θth can be used in addition to or in place of the accelerator opening degree θacc, for example.

The driver condition sensor 73 includes a camera configured to photograph, for example, a facial expression and pupils of eyes of the vehicle driver and/or a biometric information sensor configured to detect biometric information of the vehicle driver, so as to detect or obtain directions of his or her eyes and face, movements of his or her eye balls and face and condition of his or her heartbeat, for example.

The vehicle-area information sensor 80 includes a lidar (Light Detection and Ranging), a radar (Radio Detection and Ranging) and/or an onboard camera, for example, so as to directly obtain information relating to a road on which the vehicle 10 is running and information relating to an object or objects present around the vehicle 10. The lidar is constituted by, for example, a plurality of lidar units configured to detect objects present in the respective front, lateral and rear sides of the vehicle 10, or a single lidar unit configured to detect objects present all around the vehicle 10. The lidar is configured to output, as the vehicle area information lard, object information that is information relating to the detected object or objects. The radar is constituted by, for example, a plurality of radar units configured to detect objects present in the respective front, front vicinity and rear vicinity of the vehicle 10, and to output, as the vehicle area information lard, object information that is information relating to the detected object or objects. The objected information outputted as the vehicle area information lard by the lidar and the radar includes a distance and a direction of each of the detected objects from the vehicle 10. The onboard camera is, for example, a monocular camera or a stereo camera configured to capture images of front and rear sides of the vehicle 10, and to output, as the vehicle area information lard, captured image information that is information relating to the captured images. The captured image information outputted as the vehicle area information lard by the onboard camera includes information relating to lanes of a running road, signs and parking spaces present on the running road, and at least one other vehicle (that is other than the vehicle 10), pedestrians and obstacles present on the running road.

The vehicle location sensor 81 includes a GPS antenna. The location information Ivp outputted by the vehicle location sensor 81 includes own-vehicle location information indicating a location of the vehicle 10 on the earth's surface or a map based on, for example, GPS signals (Orbit signals) transmitted by GPS (Global Positioning System) satellites.

The navigation system 83 is a known navigation system including a display and a speaker, and is configured to specify a location of the vehicle 10 on pre-stored map data, based on the location information Ivp, and to indicate the location of the vehicle 10 on the map displayed on the display. The navigation system 83 receives a destination point inputted thereto, calculates a running route from a departure point to the destination point, and informs, as instructions, the vehicle driver of the running route, for example, through the display and the speaker. The navigation information Inavi includes map information such as road information and facility information that are based on the map data pre-stored in the navigation system 83. The road information includes information relating to types of roads (such as urban roads, suburban roads, mountain roads and highway road), branching and merging of roads, road gradients, and running speed limits. The facility information includes information of types, locations, names of sites such as supermarkets, shops, restaurants, parking lots, parks, sites for repairing the vehicle 10, a home of vehicle's owner and service areas located on the highway road. The service areas are sites which are located on, for example, the highway road, and in which there are facilities for parking, eating, and refueling.

The drive-assist setting switches 84 include an automatic-drive selecting switch for executing the automatic drive control, a cruise switch for executing the cruise control, a switch for setting the vehicle running speed in execution of the cruise control, a switch for setting a distance from another vehicle preceding the vehicle 10 in execution of the cruise control, and a switch for executing a lane keeping control for keeping the vehicle 10 to run within a selected road lane.

The communication signal Scom includes road traffic information that is transmitted and received to and from a center that is an external device such as a road traffic information communication system, and/or inter-vehicle communication information that is directly transmitted and received to and from the at least one other vehicle present in the vicinity of the vehicle 10 without via the center. The road traffic information includes information relating to traffic jams, accidents, road constructions, required travel times, and parking lots on roads. The inter-vehicle communication information includes vehicle information, running information, traffic environment information. The vehicle information includes information indicative of a vehicle type of the at least one other vehicle such as passenger vehicle, truck, and two-wheel vehicle. The running information includes information relating to the at least one other vehicle such as information indicative of the vehicle running speed V, location information, brake-pedal operation information, turn-signal-lamp blinking information, and hazard-lamp blinking information. The traffic environment information includes information relating to traffic jams and road constructions.

The electronic control device 90 generates various output signals to the various devices provided in the vehicle 10, such as: an engine control command signal Se that is to be supplied to the engine control device 50 for controlling the engine 14, rotating-machine control command signals Smg that are to be supplied to the inverter 52 for controlling the first and second rotating machines MG1, MG2; hydraulic control command signal Sat that is to be supplied to the hydraulic control unit 56 for controlling the operation states of the engagement devices CB; the communication signal Scom that is to be supplied to the external-network communication antenna 82; a brake-control command signal Sbra that is supplied to a wheel brake device 86, for controlling a braking torque generated by the wheel brake device 86; a steering-control command signal Sste that is to be supplied to a steering device 88, for controlling steering of wheels (especially, front wheels) of the vehicle 10; and an information-notification-control command signal Sinf that is to be supplied to an information notification device 89, for warning and notifying information to the vehicle driver.

The wheel brake device 86 is a brake device including wheel brakes each of which is configured to apply a braking torque to a corresponding one of the wheels that include the drive wheels 28 and driven wheels (not shown). The wheel brake device 86 supplies a brake hydraulic pressure to a wheel cylinder provided in each of the wheel brakes in response to a depressing operation of the brake pedal by the vehicle driver, for example. In the wheel brake device 86, normally, a brake master cylinder is configured to generate a master-cylinder hydraulic pressure whose magnitude corresponds to the braking operation amount Bra, and the generated master-cylinder hydraulic pressure is supplied as the brake hydraulic pressure to the wheel cylinder. On the other hand, in the wheel brake device 86, for example, during execution of an ABS control, an anti-skid control, a vehicle-running-speed control or an automatic drive control, the brake hydraulic pressure required for execution of such a control is supplied to the wheel cylinder for enabling the wheel cylinder to generate a required braking torque.

The steering device 88 is configured to apply an assist torque to a steering system of the vehicle 10 in accordance with the vehicle running speed V, steering angle θsw, steering direction Dsw and yaw rate Ryaw, for example. For example, during execution of the automatic drive control, the steering device 88 applies a torque for controlling the steering of the front wheels, to the steering system of the vehicle 10.

The information notification device 89 is configured to give a warning or notification to the vehicle driver in even of a failure that affects the running of the vehicle 10 or deterioration in functions of the components, for example. The information notification device 89 is constituted by, for example, a display device such as a monitor, a display and an alarm lamp, and/or a sound output device such as a speaker and a buzzer. The display device is configured to visually give a warning or notification to the vehicle driver. The sound output device is configured to aurally give a warning or notification to the vehicle driver.

The electronic control device 90 includes a first storage device 91 such as a rewritable ROM. The first storage device 91 is a storage device configured to store therein a vehicle control software 92 that is to be used for controlling the vehicle 10 by the electronic control device 90. The vehicle control software 92 includes a plurality of kinds of vehicle control programs 92P each defining a control procedure according to which the vehicle 10 is to be controlled, and also a plurality of kinds of control data 92D each of which is to be used when the vehicle 10 is controlled in accordance with a corresponding one of the vehicle control programs 92P.

The vehicle 10 further includes a transceiver 100, a first gateway ECU 110, an update control device 120, a second gateway ECU 130 and a connector 140.

The transceiver 100 is a device configured to communicate with a server 200 as an external device which is present apart from the vehicle 10 and is provided outside the vehicle 10.

Each of the first gateway ECU 110, update control device 120 and second gateway ECU 130 has substantially the same hardware construction as the electronic control device 90, and is a control device configured to rewrite the vehicle control software 92 that is stored in, for example, the first storage device 91.

The connector 140 is provided to enable an external rewriting device 210 to be connected to the vehicle 10, wherein the external rewriting device 210 is an external device which is present apart from the vehicle 10 and is provided outside the vehicle 10. A shape of the connector 140 and an electrical signal that is to be transmitted through the connector 140 are defined or determined by a known standard. The connector 140 can be used as a connector through which a failure diagnostic device is connected to the vehicle 10. As the standard of the connector 140, there are OBD (On-Board Diagnostics), WWH-OBD (World Wide Harmonized-OBD), KWP (Keyword Protocol) and UDS (Unified Diagnostic Services), for example. The connector 140 is referred to as OBD connector, DLC connector or failure diagnostic connector, for example.

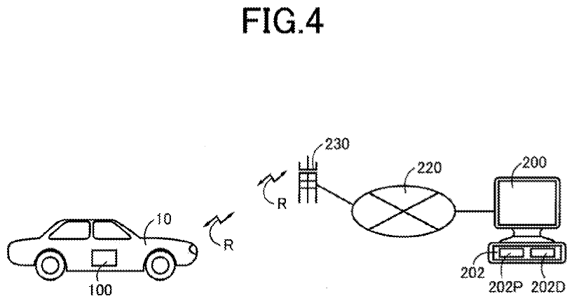

As shown in FIG. 4, the server 200 is a system connected to a network 220 that is provided outside the vehicle 10. The server 200 is configured to store therein a new software 202 uploaded thereto, and to transmit the new software 202 to the vehicle 10 as needed. The server 200 serves as a software distribution center for distributing the new software 202. The new software 202 is a software to which the current vehicle control software 92 is to be updated. That is, the new software 202 is to become an updated vehicle control software 92 after the current vehicle control software 92 is updated to the new software 202, namely, after the current vehicle control software 92 is rewritten to the new software 202. The new software 202 includes a plurality of kinds of new programs 202P to each of which a corresponding one of the vehicle control programs 92P is to be updated, and also a plurality of kinds of new data 202D to each of which a corresponding one of the control data 92D is to be updated. Each of the new programs 202P is to become an updated vehicle control program 92P after the corresponding current vehicle control program 92P is updated to the new program 202P, namely, after the corresponding current vehicle control program 92P is rewritten to the new program 202P. Each of the new data 202D is to become an updated control data 92D after the corresponding current control data 92D is updated to the new data 202D, namely, after the corresponding current control data 92D is rewritten to the new data 202D. In the following description of the present embodiment, the current vehicle control software 92 will be referred to as a current software 92.

The external rewriting device 210 is to be connected directly to an in-vehicle network of the vehicle 10, so that the external rewriting device 210 as well as the electronic control device 90, for example, can receive CAN (Controller Area Network) frame through the in-vehicle network and transmit the CAN frame to the in-vehicle network.

As shown in FIG. 4, the transceiver 100 is connected through a wireless communication R to the network 220 that is connected to a wireless device 230 through the wireless communication R. The wireless device 230, which is located outside the vehicle 10, is a transceiver device configured to transmit and receive various signals through the wireless communication R.

The first gateway ECU 110 is connected to the transceiver 100, and is configured to receive, as needed, the new software 202 transmitted from the server 200 through the wireless communication R, and to transmit the received new software 202 to the update control device 120. It is noted that the wireless communication R may be made between the vehicle 10 and the server 200 also through the external-network communication antenna 82.

The update control device 120 is a control device configured to supervise writing and rewriting of the vehicle control software 92 through the wireless communication R in the vehicle 10. The update control device 120 is configured to rewrite the vehicle control software 92 by using the new software 202 transmitted from the first gateway ECU 110.

For performing function of updating the vehicle control software 92, the update control device 120 includes an update processing means in the form of an update processing portion 122 and a second storage device 124 such as a rewritable ROM.

The update processing portion 122 is configured to determine whether the server 200 contains the new software 202 that is to be transmitted to the vehicle 10 so as to update the vehicle control software 92 to the new software 202, namely, whether the new software 202 exists in the server 200 for updating the vehicle control software 92 to the new control software 92. In other words, the update processing portion 122 is configured to determine where there exists a request requesting transmission of the new software 202 from the server 200 so as to update the vehicle control software 92 to the new software 202, namely, whether there exists a request requesting the new software 202 to be transmitted from the server 200 so as to be written into the update control device 120.

When determining that there exists a request for reception of the new software 202 from the server 200 and writing of the new software 202 into the update control device 120, the update processing portion 122 transmits, to the first gateway ECU 110, a command requesting the new software 202 to be received or downloaded from the server 200 through the wireless communication R. Then, the update processing portion 122 stores, as a received new software 126, the new software 202 received by the first gateway ECU 110 from the server 200, in the second storage device 124. The second storage device 124 is a storage device configured to store therein the received new software 126, i.e., the new software 202 received from the server 200. The received new software 126 includes received new programs 126P that are the new programs 202P stored in the second storage device 124, and also received new data 126D that are the new data 202D stored in the second storage device 124.

The update processing portion 122 rewrites the vehicle control software 92 by using the received new software 126, namely, executes update processing for updating the vehicle control software 92 to the received new software 126. That is, the update processing portion 122 executes the update processing for updating the vehicle control software 92, by writing the new software 202 stored in the second storage device 124, into the first storage device 91.

The second gateway ECU 130 is connected to the connector 140, for rewriting the vehicle control software 92 by using the external rewriting device 210 that is connected to the second gateway ECU 130 through the connector 140. It is noted that, although the vehicle 10 and the external rewriting device 210 are wire-connected to each other through the connector 140 in the present embodiment, they may be connected to each other in a wireless manner.

The electronic control device 90 as a first control device and the update control device 120 as a second control device cooperate with each other to constitute a vehicle control apparatus 150 configured to execute vehicle control for controlling the vehicle 10 and to execute update processing for updating the vehicle control software 92. That is, the vehicle control apparatus 150 constituted by the electronic control device 90 and the update control device 120 configured to control the vehicle 10 and to execute the update processing for updating the vehicle control software 92 by using the new software 202 that is received through the wireless communication R from the server 200 as the external device that is provided outside the vehicle 10. Thus, the vehicle control apparatus 150 is provided with the electronic control device 90 and the update control device 120.

For performing various control operations in the vehicle 10, the electronic control device 90 further includes an AT shift control means in the form of an AT shift control portion 93, a hybrid control means in the form of a hybrid control portion 94, a braking-force control means in the form of a braking-force control portion 95 and a driving control means in the form of a driving control portion 96.

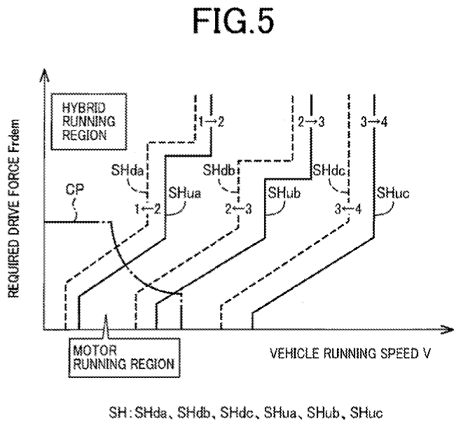

The AT shift control portion 93 is configured to determine a shifting action of the step-variable transmission portion 20, by using, for example, an AT-gear-position shifting map as shown in FIG. 5, which is a relationship obtained by experimentation or determined by an appropriate design theory, and to output the hydraulic control command signal Sat supplied to the hydraulic control unit 56, so as to execute a shift control operation in the step-variable transmission portion 20 as needed.

The AT-gear-position shifting map shown in FIG. 5 represents a predetermined relationship between two variables in the form of the vehicle running speed V and the required drive force Frdem, for example, wherein the relationship is used in the shift control operation executed in the step-variable transmission portion 20, and wherein the AT-gear-position shifting map contains a plurality of kinds of shifting lines SH in two-dimensional coordinates in which the vehicle running speed V and the required drive force Frdem are taken along respective two axes. The shifting lines SH are used to determine whether the shifting action is to be executed in the step-variable transmission portion 20, namely, whether a currently established one of the AT gear positions is to be switched to another one of the AT gear positions. It is noted that one of the two variables may be the output rotational speed No in place of the vehicle running speed V and that the other of the two variables may be the required drive torque Trdem, accelerator opening degree θacc or throttle valve opening degree θth in place of the required drive force Frdem. The shifting lines SH in the AT gear position shifting map consist of shift-up lines SHua, SHub, SHuc (indicated by solid lines in FIG. 5) for determining a shift-up action of the step-variable transmission portion 20, and shift-down lines SHda, SHdb, SHdc (indicated by broken lines in FIG. 5) for determining a shift-down action of the step-variable transmission portion 20.

The hybrid control portion 94 has a function serving as an engine control means or portion for controlling the operation of the engine 14 and a function serving as a rotating machine control means or portion for controlling the operations of the first rotating machine MG1 and the second rotating machine MG2 via the inverter 52, and executes a hybrid drive control, for example, using the engine 14, the first rotating machine MG1 and the second rotating machine MG2 through these control functions.

The hybrid control portion 94 calculates a drive request amount in the form of the required drive force Frdem that is to be applied to the drive wheels 28, by applying the accelerator opening degree θacc and the vehicle running speed V to, for example, a drive request amount map that is a predetermined relationship. The required drive torque Trdem [Nm] applied to the drive wheels 28, a required drive power Prdem [W] applied to the drive wheels 28 or a required AT output torque applied to the output shaft 22, for example, can be used as the drive request amount, in addition to the required drive force Frdem [N]. The hybrid control portion 94 outputs the engine control command signal Se for controlling the engine 14 and the rotating-machine control command signals Smg for controlling the first and second rotating machines MG1, MG2, by taking account of a maximum chargeable amount Win of electric power that can be charged to the battery 54, and a maximum dischargeable amount Wout of electric power that can be discharged from the battery 54, such that the required drive power Prdem based on the required drive torque Trdem and the vehicle running speed V is obtained. The engine control command signal Se is, for example, a command value of an engine power Pe that is the power of the engine 14 outputting the engine torque Te at the current engine rotational speed Ne. The rotating-machine control command signal Smg is, for example, a command value of the generated electric power Wg of the first rotating machine MG1 outputting the MG1 torque Tg as the reaction torque of the engine torque Te at the MG1 rotational speed Ng which is the MG1 rotational speed Ng at the time of command signal Smg output, and is a command value of a consumed electric power Wm of the second rotating machine MG2 outputting the MG2 torque Tm at the MG2 rotational speed Nm which is the MG2 rotational speed Nm at the time of command signal Smg output.

The maximum chargeable amount Win of the battery 54 is a maximum amount of the electric power that can be charged to the battery 54, and indicates an input limit of the battery 54. The maximum dischargeable amount Wout of the battery 54 is a maximum amount of the electric power that can be discharged from the battery 54, and indicates an output limit of the battery 54. The maximum chargeable and dischargeable amounts Win, Wout are calculated by the electronic control device 90, for example, based on a battery temperature THbat and a charged state value SOC [%] of the battery 54. The charged state value SOC of the battery 54 is a value indicative of a charged state of the battery 54, i.e., an amount of the electric power stored in the battery 54, and is calculated by the electronic control device 90, for example, based on the charging/discharging electric current Ibat and the voltage Vbat of the battery 54.

For example, when the transmission device 40 is operated as a continuously variable transmission as a whole by operating the continuously variable transmission portion 18 as a continuously variable transmission, the hybrid control portion 94 controls the engine 14 and controls the generated electric power Wg of the first rotating machine MG1 so as to attain the engine rotational speed Ne and the engine torque Te at which the engine power Pe achieving the required drive power Prdem is acquired in consideration of an optimum engine operation point, for example, and thereby provides the continuously variable shift control of the continuously variable transmission portion 18 to change the gear ratio γ0 of the continuously variable transmission portion 18. As a result of this control, the gear ratio γt (=γ0×γat=Ne/No) of the transmission device 40 is controlled in the case of operating the transmission device 40 as a continuously variable transmission. The optimum engine operation point is an engine operation point that maximizes a total fuel efficiency in the vehicle 10 including not only a fuel efficiency of the engine 14 but also a charge/discharge efficiency of the battery 54, for example, when a required engine power Pedem [W] is to be acquired. The engine operation point is an operation point of the engine 14 which is defined by a combination of the engine rotational speed Ne and the engine torque Te.

For example, when the transmission device 40 is operated as a step-variable transmission as a whole by operating the continuously variable transmission portion 18 as in a step-variable transmission, the hybrid control portion 94 uses a predetermined relationship, for example, a step-variable gear position shift map, to determine need of a shifting action of the transmission device 40 and provides the shift control of the continuously variable transmission portion 18 so as to selectively establish the plurality of overall gear positions in coordination with the shift control of the AT gear position of the step-variable transmission portion 20 by the AT shift control portion 93. The plurality of overall gear positions can be established by controlling the engine rotational speed Ne by the first rotating machine MG1 depending on the output rotational speed No so as to maintain the respective gear ratios γt.

The hybrid control portion 94 selectively establishes the EV running mode or the HV running mode as the running mode depending on a driving state, so as to cause the vehicle 10 to run in a selected one of the running modes which is selected by using, for example, a predetermined relationship in the form of a drive-power-source switching map as shown in FIG. 5. For example, the hybrid control portion 94 selects and establishes the EV running mode when the required drive power Prdem is relatively small so as to be in an EV running region, and selects and establishes the HV running mode when the required drive power Prdem is relatively large so as to be in an HV running region.

The drive-power-source switching map shown in FIG. 5 represents a predetermined relationship between two variables in the form of the vehicle running speed V and the required drive force Frdem, for example, and contains a boundary line (indicated by one-dot chain line) between the HV running region and the EV running region in two-dimensional coordinates in which the vehicle running speed V and the required drive force Frdem are taken along respective two axes, wherein the boundary line is used for switching the running mode between the HV running mode and the EV running mode. Since the drive power source used to drive the vehicle 10 is switched upon switching of the running mode, the above-described boundary line is a predetermined drive-power-source switching line CP that is used for determining whether the drive power source used to drive the vehicle 10 is to be switched, namely, whether the running mode is to be switched from one of the EV running mode and the HV running mode to another. The drive-power-source switching line CP is also to a predetermined running-region switching line or a predetermined running-region boundary line that is used for determining whether one of the EV running and the HV running is to be switched to another. It is noted that, in FIG. 5, the drive-power-source switching line is shown together with AT-gear-position shifting map, for convenience of the description.

Even when the required drive power Prdem is in the EV running region, the hybrid control portion 94 establishes the HV running mode, for example, in a case in which the charged state value SOC of the battery 54 becomes less than a predetermined engine-start threshold value or in a case in which the engine 14 needs to be warmed up. The engine-start threshold value is a predetermined threshold value for determining that the charged state value SOC reaches a level at which the engine 14 must forcibly be started for charging the battery 54.

When establishing the HV running mode upon stop of operation of the engine 14, the hybrid control portion 94 executes a control for staring the engine 14. For staring the engine 14, the hybrid control portion 94 increases the engine rotational speed Ne by the first rotating machine MG1, and starts the engine 14, by igniting when the engine rotational speed Ne becomes at least a certain speed value that is an ignitable speed value. That is, the hybrid control portion 94 starts the engine 14 by cranking the engine 14 by the first rotating machine MG1.

The braking-force control portion 95 calculates a target degree of deceleration, for example, based on the accelerating operation (e.g., the accelerator opening degree θacc, a rate of reduction of the accelerator opening degree θacc) made by the vehicle driver, the vehicle running speed V, a gradient of downhill road and the braking operation (e.g., the braking operation amount Bra, a rate of increase of the braking operation amount Bra) made by the vehicle driver to operate the wheel brakes, and determines a required braking force Bdem that realizes the target degree of deceleration, by using a predetermined relationship. During deceleration running of the vehicle 10, the braking-force control portion 95 controls a total braking force acting on the vehicle 10, so as to obtain the required braking force Bdem.

The total braking force acting on the vehicle 10 is constituted, for example, by a regenerative braking force that is the braking force generated by the second rotating machine MG2 subjected to a regenerative control and a wheel braking force that is the braking force generated by the wheel brake device 86, such that the regenerative braking force is generated with a higher priority, for example, in view of improvement of an energy efficiency. The braking-force control portion 95 outputs a command requesting execution of the regenerative control by which a regenerative torque required for the regenerative braking force is to be generated by the second rotating machine MG2, and the outputted command is supplied to the hybrid control portion 94. The regenerative control to which the second rotating machine MG2 is to be subjected is a control for causing the second rotating machine MG2 to be driven and rotated by a driven torque inputted from each of the drive wheels 28 so as to be operated as the generator, such that the battery 54 is charged with the generated electric power through the inverter 52.

The braking-force control portion 95 realizes the required braking force Bdem by exclusively the regenerative braking force, for example, when the required braking force Bdem is relatively small, and realizes the required braking force Bdem by the wheel braking force in addition to the regenerative braking force, for example, when the required braking force Bdem is relatively large. Further, shortly before the vehicle 10 is stopped, for example, the braking-force control portion 95 realizes the required braking force Bdem by replacing the regenerative braking force with the wheel braking force. The braking-force control portion 95 outputs the brake-control command signal Sbra for obtaining the wheel braking force that is required to realize the required braking force Bdem, and the outputted the brake-control command signal Sbra is supplied to the wheel brake device 86.

The driving control portion 96 is capable of executing, as a drive control for driving the vehicle 10, a selected one of a manual drive control for driving the vehicle 10 in accordance with driving operations made by the vehicle driver and a drive assist control for driving the vehicle 10 without depending on the driving operations made by the vehicle driver. The manual drive control is for causing the vehicle 10 to run by manual operations, i.e., the driving operation manually made by the vehicle driver. The manual drive control is a driving method for casing the vehicle 10 to run by the vehicle driver's driving operations such as an accelerating operation, a barking operation and a steering operation. The drive assist control is for causing the vehicle 10 to run, for example, with a drive assist by which the driving operations are automatically assisted. The drive assist is a driving method for causing the vehicle 10 to run, for example, by automatically accelerating, decelerating and braking the vehicle 10, by controls executed by the electronic control device 90, based on the signals and information supplied from the various sensors, without depending on the driving operations made by the vehicle driver, namely, without depending on intentions of the vehicle driver. The drive assist control is, for example, the automatic drive control in which the vehicle 10 is accelerated, decelerated, braked and steered, depending on a target driving state that is automatically determined based on, for example, the map information and the destination point inputted by the vehicle driver. It is noted that the drive assist control may be broadly interpreted to encompass the cruise control in which some of the driving operations such as the steering operation are executed by the vehicle driver while the other driving operations such as the accelerating, decelerating and braking operations are automatically executed.

When a drive-assist mode is not selected with the automatic-drive selecting switch and the cruise switch of the drive-assist setting switches 84 being placed in OFF, the driving control portion 96 establishes a manual drive mode so as to execute the manual drive control. The driving control portion 96 executes the manual drive control by outputting commands for controlling the step-variable transmission portion 20, engine 14, first and second rotating machines MG1, MG2 and wheel brake device 86, wherein the commands are supplied to the AT shift control portion 93, hybrid control portion 94 and braking-force control portion 95, such that the vehicle 10 is accelerated, decelerated and braked, for example, in accordance with the driving operation manually made by the vehicle driver.

When an automatic drive mode is selected with the automatic-drive selecting switch of the drive-assist setting switches 84 being placed in ON by the vehicle driver, the driving control portion 96 establishes the automatic drive mode so as to execute the automatic drive control. Specifically, the driving control portion 96 automatically sets a target driving state that is dependent on, for example, the destination point inputted by the vehicle driver, the own-vehicle location information based on the location information Ivp, the map information based on the navigation information Inavi and various information relating to the running road and based on the vehicle area information lard. The driving control portion 96 executes the automatic drive control for automatically accelerating, decelerating, braking and steering the vehicle 10, based on the set target driving state. To this end, the driving control portion 96 outputs the commands for controlling the step-variable transmission portion 20, engine 14, rotating machines MG1, MG2 and wheel brake device 86, and the outputted commands are supplied to the AT shift control portion 93, the hybrid control portion 94 and braking-force control portion 95. Further, in this instance, the driving control portion 96 outputs the steering-control command signal Sste for controlling steering of the front wheels, and the outputted steering-control command signal Sste is supplied to the steering device 88.

The vehicle control programs 92P include, for example, an engine program 92Peg that is an engine control program to be used for controlling the engine 14 by the hybrid control portion 94, an MG1 program 92Pm1 that is a first-rotating-machine control program to be used for controlling the first rotating machine MG1 by the hybrid control portion 94, an MG2 program 92Pm2 that is a second-rotating-machine control program to be used for controlling the second rotating machine MG2 by the hybrid control portion 94, and an AT program 92Pat that is an automatic-transmission control program to be used for controlling the step-variable transmission portion 20 by the AT shift control portion 93. The MG2 program 92Pm2 is a rotating-machine control program to be used for controlling the rotating machine serving as the drive power source. The MG2 program 92Pm2 includes an EV program 92Pev that is a motor running program to be used for the EV running and also a regeneration program 92Pre that is a regenerative control program to be used for the regenerative control by the second rotating machine MG2.

The control data 92D includes the plurality kinds of shifting lines SH, the drive-power-source switching line CP, and limit values GD for limiting correction values or amounts which are obtained through learning control and by which respective control values Set (used for controlling the vehicle 10) are to be corrected. The control values Set are various command signals such as the above-described engine control command signal Se, rotating-machine control command signals Smg, hydraulic control command signal Sat, brake-control command signal Sbra and steering-control command signal Sste. The hydraulic control command signal Sat included in the control values Set is, for example, an engaging-pressure command value in accordance with which the engaging pressure of the engagement device CB, whose operation state is switched in process of a shifting action executed in the step-variable transmission portion 20 by the AT shift control portion 93, is controlled to be changed. The AT shift control portion 93 corrects the engaging-pressure command value through the learning control, for example, such that the shifting action can be completed in the step-variable transmission portion 20 within an appropriate length of time, with a shitting shock being suppressed. The limit values GD are guard values provided for the respective various control values Set, for example, such that each of the control values Set is not changed excessively by the learning control.

The electronic control device 90 includes a vehicle-control execution portion 97 configured to control the vehicle 10 by using the vehicle control software 92, namely, to control the vehicle 10 in accordance with the vehicle control programs 92P. The vehicle-control execution portion 97 includes the above-described AT shift control portion 93, hybrid control portion 94, braking-force control portion 95 and driving control portion 96.

By the way, when the update processing is executed for updating the current software 92 by using the new software 202, i.e., the received new software 126, there is a possibility of failure in writing the received new software 126 into the first storage device 91 of the electronic control device 90. In the update processing for updating the vehicle control software 92, the writing of the received new software 126 is made after the current software 92 is erased, or the writing of the received new software 126 is made by overwriting the received new software 126 into a storage region in which the current software 92 is stored. Therefore, in the event of the failure in writing the received new software 126, the control of the vehicle 10 with use of the updated vehicle control software 92 cannot be executed. However, in an arrangement in which the electronic control device 90 backs up the current software 92 prior to execution of the update processing for updating the vehicle control software 92, the control of the vehicle 10 can be executed by using the current software 92 that has been backed up in the event of the failure in writing the received new software 126. In this arrangement, if the current software 92 is backed up in a storage region of the electronic control device 90, the electronic control device 90 would need to be provided with a storage device having a large capacity as a whole.

The vehicle 10 is provided with the update control device 120 apart from the electronic control device 90. The second storage device 124 of the update control device 120 has a capacity of at least a certain level, for a possible need to store the plurality of kinds of new softwares 202, for example, in a case in which the update processing of the vehicle control software 92 is deferred or in a case in which there is a request of transmission of the plurality of kinds of new softwares 20 from the server 200. The electronic control device 90 causes the current vehicle control software 92 to be backed up in the second storage device 124 prior to execution of the update processing of the vehicle control software 92.

Specifically described, the electronic control device 90 further includes a state determining means in the form of a state determining portion 98 and a backup processing means in the form of a backup processing portion 99, so that, even in the event of failure in the update processing of the current vehicle control software 92, the electronic control device 90 can revive the current vehicle control software 92 and use the current vehicle control software 92 for controlling the vehicle 10.

The state determining portion 98 is configured, when the received new software 126 is stored in the second storage device 124, to make a determination as to whether execution of the update processing of the vehicle control software 92 is to be allowed or not, namely, to make a determination as to whether writing of the received new software 126 into the first storage device 91 of the electronic control device 90 is to be allowed or not. The state determining portion 98 makes this determination, depending on whether the current operation for control of the vehicle 10 can be executed without trouble or problem even if the update processing of the vehicle control software 92 is executed, or not.

The state determining portion 98 determines that the current operation for control of the vehicle 10 cannot be executed without trouble or problem if the update processing of the vehicle control software 92 is executed, in a case in which the vehicle 10 is being currently controlled with use of the vehicle control software 92 that is to be subjected to the update processing.

For example, the EV running is a running with use of the vehicle control software 92 involved in control for the EV running. Therefore, during the EV running, when the update processing is executed to update the vehicle control software 92, the EV running cannot be performed without problem, if the updated vehicle control software 92 is involved in the control for the EV running. On the other hand, during the EV running, even when the update processing is executed to update the vehicle control software 92, the EV running is likely to be performed without problem, as long as the updated vehicle control software 92 is not involved in the control for the EV running. The vehicle control software 92 involved in the control for the EV running includes the MG2 program 92Pm2. On the other hand, the vehicle control software 92 that is not involved in the control for the EV running includes the vehicle control software 92 involved in the control for the HV running, the shifting lines SH, the drive-power-source switching line CP and the limit values GD. The vehicle control software 92 involved in the control for the HV running includes the engine program 92Peg and the MG1 program 92Pm1 in accordance of which the first rotating machine MG1 is to be controlled to output a reaction torque acting against the engine torque Te. When the vehicle 10 is performing the EV running, the state determining portion 98 does not allow writing of the received new software 126 (to which the vehicle control software 92 involved in the control for the EV running, is to be updated) into the first storage device 91, but allows writing of the received new software 126 (to which the vehicle control software 92 not involved in the control for the EV running, is to be updated) into the first storage device 91. When the vehicle 10 is not performing the EV running, too, the state determining portion 98 makes a determination as to whether the writing of the received new software 126 into the first storage device 91 is to be allowed or not, in accordance with the same criteria as when the vehicle 10 is performing the EV running.

The learning control of the control values Set by the vehicle control apparatus 150 is a control that is to be executed, for example, after a kind of control of the vehicle 10 subjected to the learning control is terminated, to correct the control values Set that to be used in the next execution of the same kind to control of the vehicle 10. Thus, the learning control is not executed during execution of a kind of control of the vehicle 10 that is subjected to the learning control. Therefore, the current operation for control of the vehicle 10 can be executed without problem, even if the update processing for updating the limit values GD used for the learning control is executed during execution of the control of the vehicle 10. Accordingly, the state determining portion 98 allows the writing of the received new software 126 to which the limit values GD are to be updated, irrespective of the current operation for control of the vehicle 10, namely, irrespective of which kind of the control of the vehicle 10 is being executed.

When it is determined by the state determining portion 98 that the writing of the received new software 126 into the first storage device 91 is not to be allowed, the update processing portion 122 defers the update processing that is to be executed to update the vehicle control software 92 to the received new software 126. On the other hand, when it is determined by the state determining portion 98 that the writing of the received new software 126 into the first storage device 91 is to be allowed, the update processing portion 122 executes the writing of the received new software 126 into the first storage device 91. Thus, the update processing portion 122 executes the update processing for updating the vehicle control software 92, when the vehicle-control execution portion 97 does not execute the control of the vehicle 10 with use of the vehicle control software 92 that is subjected to the update processing.

Prior to execution of the update processing of the vehicle control software 92 by the update processing portion 122, the backup processing portion 99 writes the vehicle control software 92, which is stored in the first storage device 91 and subjected to the update processing, into the second storage device 124, whereby the vehicle control software 92 subjected to the update processing is backed up in the second storage device 124.

The state determining portion 98 determines whether the writing of the vehicle control software 92 (subjected to the update processing) into the second storage device 124 has been completed by the backup processing portion 99 or not.

When it is determined by the state determining portion 98 that the writing of the vehicle control software 92 (subjected to the update processing) into the second storage device 124 has been completed by the backup processing portion 99, the update processing portion 122 starts to write the received new software 126 into the first storage device 91 after the vehicle control software 92 (subjected to the update processing) has been erased from the first storage device 91 by the backup processing portion 99. It is note that the vehicle control software 92 does not have to be erased in a case in which the writing of the received new software 126 is made by overwriting the received new software 126 onto the vehicle control software 92 (subjected to the update processing).

The state determining portion 98 makes a determination as to whether the writing of the received new software 126 into the first storage device 91 has been completed by the update processing portion 122 or not. When determining that the writing of the received new software 126 into the first storage device 91 has been completed by the update processing portion 122, the state determining portion 98 makes a determination as to whether the writing of the received new software 126 into the first storage device 91 has been successfully made without failure or not, namely, whether the update processing for updating the vehicle control software 92 has been successfully executed or not. In the present embodiment, the state determining portion 98 makes this determination, for example, by a so-called verification that is made by checking if there is no error found in the received new software 126 that has been completely written into the first storage device 91, namely, by checking if there is no error found in the updated vehicle control software 92. However, the state determining portion 98 may make the above-described determination, for example, by checking if the control can be successfully executed by operating the updated vehicle control software 92 in a virtual space.

When it is determined by the state determining portion 98 that the update processing for updating the vehicle control software 92 has not been successfully executed by the update processing portion 122, the backup processing portion 99 writes the vehicle control software 92, which has been subjected to the update processing and written into the second storage device 124, back into the first storage device 91.

The state determining portion 98 makes a determination as to whether the writing of vehicle control software 92 (that has been subjected to the update processing and written into the second storage device 124) back into the first storage device 91 has been completed by the backup processing portion 99 or not.

When it is determined by the state determining portion 98 that the update processing for updating the vehicle control software 92 has been successfully executed by the update processing portion 122, the backup processing portion 99 erases the vehicle control software 92 (that has been subjected to the update processing and written into the second storage device 124) from the second storage device 124.

After the writing of the received new software 126 into first storage device 91 has been successfully completed by the update processing portion 122, the received new software 126 stored in the second storage device 124 is erased from the second storage device 124 and the vehicle control software 92 (that has been subjected to the update processing and written into the second storage device 124) is also erased from the second storage device 124. Therefore, after the received new software 126 and the vehicle control software 92 have been erased from the second storage device 124, usually or basically, the second storage device 124 has a capacity enough to store therein the new software 202 whose writing thereinto has been requested by the server 200 and also the vehicle control software 92 that is to be updated to the new software 202. However, for example, in a case in which the plurality of kinds of the new softwares 202 are stored in the second storage device 124, there is a risk that the vehicle control software or softwares 92 subjected to the update processing could not be written into the second storage device 124, depending on a volume of each of the new softwares 202. In such a case, the capacity of the second storage device 124 is insufficient to receive and write therein another new software 202 transmitted from the server 200, in addition to the new software or softwares 202 that have been already written and stored in the second storage device 124. The update control device 120 rejects or inhibits the writing of the other new software 202 into the second storage device 124, when the capacity of the second storage device 124 is insufficient to allow the other new software 202 to be written into the second storage device 124.

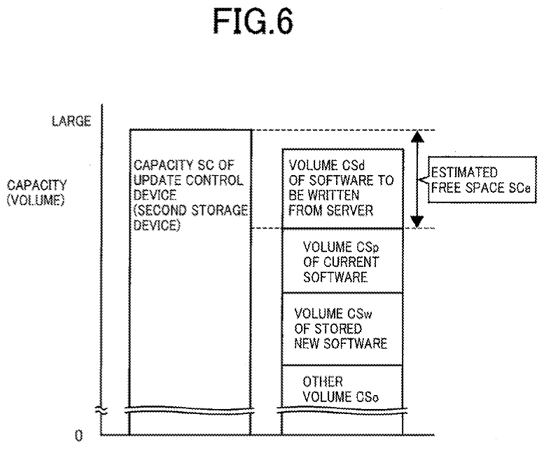

FIG. 6 is a view showing, by way of example, a case in which the received new software 126 is stored in the second storage device 124 and the writing of the other new software 202 into the second storage device 124 is requested, wherein the writing of the other new software 202 is allowed. In FIG. 6, “OTHER VOLUME CSo” represents a volume Cso of a software used for control of the update processing portion 122, for example. “VOLUME CSw OF STORED NEW SOFTWARE” represents a volume CSw of the received new software 126, i.e., the new software 202 that has been already written into the second storage device 124 and stored in the second storage device 124. “VOLUME CSp OF CURRENT SOFTWARE” represents a volume CSp of the current software 92 which will be written into the second storage device 124 by the backup processing portion 99 prior to execution of the update processing by the update processing portion 122 for updating the current software 92 to the new software 202 that has been already written into the second storage device 124. “VOLUME CSd OF SOFTWARE TO BE WRITTEN FROM SERVER” represents a volume CSd of the other new software 202 requested to be received from the server 200 and written into the second storage device 124. “CAPACITY SC OF UPDATE CONTROL DEVICE (SECOND STORAGE DEVICE)” represents a capacity SC of the second storage device 124. In the example shown in FIG. 6, the “CAPACITY SC OF UPDATE CONTROL DEVICE (SECOND STORAGE DEVICE)” is not insufficient with respect to even a total obtained by adding the “VOLUME CSd OF SOFTWARE TO BE WRITTEN FROM SERVER” to a sum of the “OTHER VOLUME CSo”, “VOLUME CSw OF STORED NEW SOFTWARE” and “VOLUME CSp OF CURRENT SOFTWARE”, so that the writing of the other new software 202 is allowed. That is, the other new software 202 is allowed to be written into the second storage device 124, because an estimated free space SCe is not smaller than the volume CSd of the other new software 202, wherein the estimated free space SCe [=SC−(CSo+CSw+CSp)] is a free space left in the second storage device 124 in a state in which the vehicle control software 92 (subjected to the update processing) will have been written into the second storage device 124 by the backup processing portion 99 prior to execution of the update processing with use of the received new software 126 by the update processing portion 122.

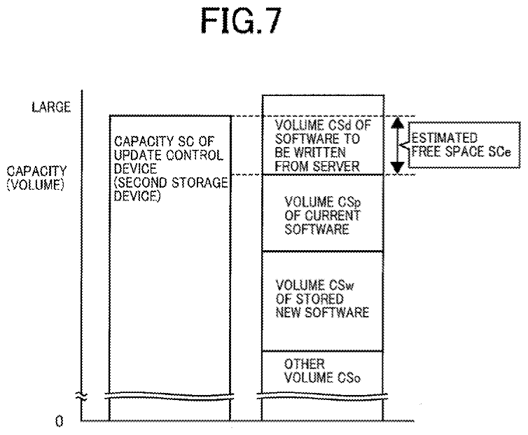

FIG. 7 is a view showing, by way of another example (that is other than the example shown in FIG. 6), a case in which the received new software 126 is stored in the second storage device 124 and the writing of the other new software 202 into the second storage device 124 is requested, wherein the writing of the other new software 202 is rejected or inhibited. In FIG. 7, the “OTHER VOLUME CSo” and the other terms are the same as those in FIG. 6. In the example shown in FIG. 7, a total obtained by adding the “VOLUME CSd OF SOFTWARE TO BE WRITTEN FROM SERVER” to a sum of the “OTHER VOLUME CSo”, “VOLUME CSw OF STORED NEW SOFTWARE” and “VOLUME CSp OF CURRENT SOFTWARE” exceeds the “CAPACITY SC OF UPDATE CONTROL DEVICE (SECOND STORAGE DEVICE)”, so that the writing of the other new software 202 is inhibited. That is, the other new software 202 is inhibited from being written into the second storage device 124, because the estimated free space SCe is smaller than the volume CSd of the other new software 202.

The update control device 120 further includes a reception processing means in the form of a reception processing portion 128, for determining whether the writing of the new software 202 into the second storage device 124 can be made or not, when the writing of the new software 202 is requested.

When it is determined by the update processing portion 122 that there is a request requesting the reception of the new software 202 from the server 200 and the writing of the new software 202 into the second storage device 124, the reception processing portion 128 makes a determination as to whether the second storage device 124 of the update control device 120 has a space left for storing the new software 202 that is requested to be received from the server 200 and to be written into the second storage device 124. Specifically, the reception processing portion 128 determines that the second storage device 124 has a sufficient space in a case in which the received new software 126 is not stored in the second storage device 124. Further, in a case in which the received new software 126 is stored in the second storage device 124, the reception processing portion 128 calculates the estimated free space SCe available for the writing of the second storage device 124, and determines whether the second storage device 124 has a sufficient space or not, depending on whether the estimated free space SCe is equal to or larger than the volume CSd of the other new software 202 requested to be received from the server 200 and written into the second storage device 124 (see FIGS. 6 and 7).

When determining that the second storage device 124 has a sufficient space, the reception processing portion 128 allows the other new software 202 (that is requested to be received from the server 200 and to be written into the second storage device 124) to be written into the second storage device 124. On the other hand, when determining that the second storage device 124 does not have a sufficient space, the reception processing portion 128 rejects or inhibits the writing of other new software 202 into the second storage device 124. Thus, when the other new software 202 other than the received new software 126 (i.e., the new software 202 that has been already written into the second storage device 124 and stored in the second storage device 124) is to be received from the server 200 and stored in the second storage device 124, the reception processing portion 128 calculates the estimated free space See left in the second storage device 124 and available for the writing of the other new software 202 into the second storage device 124, and rejects or inhibits the writing of the other new software 202 into the second storage device 124 when the estimated free space See is smaller than the volume CSd of the other new software 202.

When the writing of the new software 202 is allowed by the reception processing portion 128, the update processing portion 122 supplies, to the first gateway ECU 110, a command requesting the new software 202 to be downloaded from the server 200 to the first gateway ECU 110, and the first gateway ECU 110 writes the downloaded new software 202 into the second storage device 124. On the other hand, when the writing of the new software 202 is rejected or inhibited by the reception processing portion 128, the update processing portion 122 defers the writing of the new software 202 into the second storage device 124.

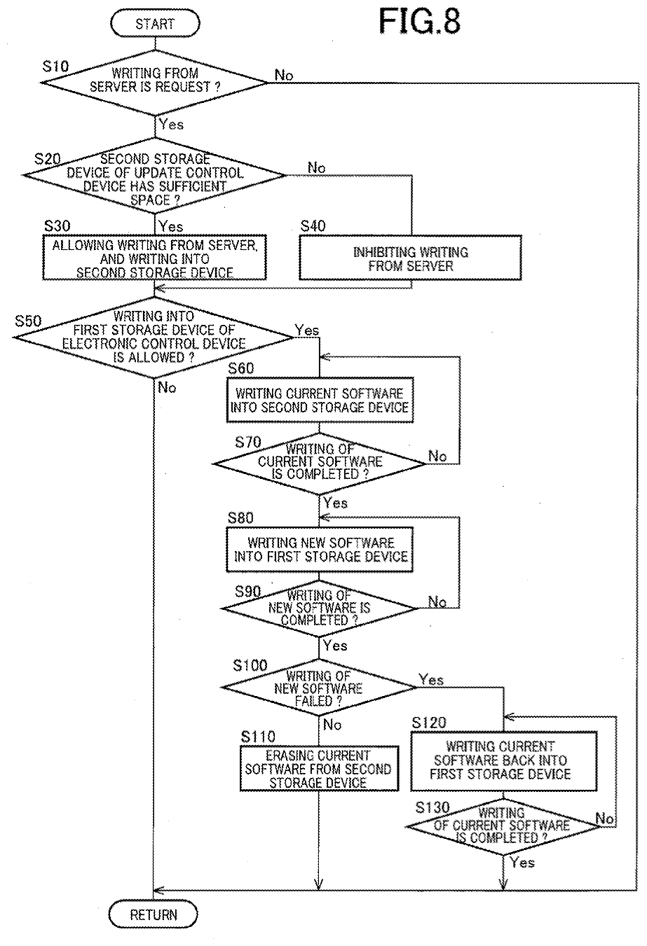

FIG. 8 is a flow chart showing a main part of a control routine executed by the vehicle control apparatus 150, namely, a control routine that is executed for making it possible to control the vehicle 10 by reviving the current software 92 in the event of failure in the update processing for updating the current software 92, while suppressing enlargement of the required capacity of the storage device as a whole of the electronic control device 90 of the vehicle control apparatus 150. This control routine is executed, for example, in a repeated manner.

As shown in FIG. 8, the control routine is initiated with step S10 corresponding to function of the update processing portion 122, which is implemented to determine whether there is a request for writing from the server 200, namely, a request requesting the new software 202 to be received from the server 200 and to be written into the second storage device 124. When a negative determination is made at step S10, one cycle of execution of the control routine is terminated. When an affirmative determination is made at step S10, step S20 corresponding to function of the reception processing portion 128 is implemented to determine whether the second storage device 124 of the update control device 120 has a sufficient space. When an affirmative determination is made at step S20, step S30 corresponding to functions of the reception processing portion 128 and the update processing portion 122 is implemented to allow the writing of the other new software 202 (that is requested to be received from the server 200 and to be written into the second storage device 124) into the second storage device 124, so that the new software 202 received from the server 200 is written into the second storage device 124. When a negative determination is made at step S20, the control flow goes to step S40 corresponding to function of the reception processing portion 128, which is implemented to inhibit the writing of the other new software 202 (that is requested to be received from the server 200 and to be written into the second storage device 124) into the second storage device 124. Step S30 or step S40 is followed by step S50 corresponding to function of the state determining portion 98, which is implemented to determine whether the writing of the new software 202, i.e., received new software 126 into the first storage device 91 of the electronic control device 90 is to be allowed. When a negative determination is made at step S50, one cycle of execution of the control routine is terminated. When an affirmative determination is made at step S50, step S60 corresponding to function of the backup processing portion 99 is implemented to write the current software 92 (that is stored in the first storage device 91 and is subjected to the update processing) into the second storage device 124. Then, step S70 corresponding to function of the state determining portion 98 is implemented to determine whether the writing of the current software 92 to the second storage device 124 has been completed. When a negative determination is made at step S70, the control flow goes back to step S60. When an affirmative determination is made at step S70, step S80 corresponding to function of the update processing portion 122 is implemented to write the received new software 126 into the first storage device 91. Then, step S90 corresponding to function of the state determining portion 98 is implemented to determine whether the writing of the received new software 126 into the first storage device 91 has been completed. When a negative determination is made at step S90, the control flow goes back to step S80. When an affirmative determination is made at step S90, step S100 corresponding to function of the state determining portion 98 is implemented to determine whether the writing of the received new software 126 into the first storage device 91 has failed. When a negative determination is made at step S100, step S110 corresponding to function of the backup processing portion 99 is implemented to erase the current software 92 (that has been written into the second storage device 124) from the second storage device 124. When an affirmative determination is made at step S100, the control flow goes to step S120 corresponding to function of the backup processing portion 99, which is implemented to write the current software 92 (that has been written into the second storage device 124) back into the first storage device 91. Then, step S130 corresponding to function of the state determining portion 98 is implemented to determine whether the writing of the current software 92 back into the first storage device 91 has been completed. When a negative determination is made at step S130, the control flow goes back to step S120. When an affirmative determination is made at step S130, one cycle of execution of the control routine is terminated.

As described above, in the present embodiment, prior to execution of the update processing for updating the current software 92 stored in the first storage device 91 of the electronic control device 90 by writing the new software 202 stored in the second storage device 124 of the update control device 120, into the first storage device 91, the current software 92 subjected to the update processing is written into the second storage device 124, so that, when the writing of the new software 202 is not successfully completed, namely, when the writing of the new software 202 results in failure, it is possible to write the current software 92 subjected to the update processing and backed up in the second storage device 124, back into the first storage device 91. Therefore, it is possible to control the vehicle 10 by reviving the current software 92 in the event of failure in the update processing for updating the current software 92 while suppressing enlargement of the capacity of the storage device as a whole of the electronic control device 90.

In the present embodiment, when the update processing of the current software 92 stored in the first storage device 91 has not been successfully executed, the current software 92 subjected to the update processing and written into the second storage device 124 prior to execution of the update processing, is written back into the first storage device 91. Therefore, it is possible to control the vehicle 10 by using the current software 92 in the event of the failure in the update processing for updating the current software 92.

In the present embodiment, when the update processing of the current software 92 stored in the first storage device 91 has been successfully executed, the current software 92 subjected to the update processing and written into the second storage device 124 prior to execution of the update processing, is erased from the second storage device 124. Thus, after the update processing of the current software 92 has been successfully executed, the backed-up current software 92 is not kept stored in the second storage device 124, so that it is possible to appropriately ensure the free space of the second storage device 124.

In the present embodiment, when the other new software 202 other than the new software 202 that has been already written into the second storage device 124 is to be stored in the second storage device 124, the estimated free space SCe left in the second storage device 124 in the state in which the current software 92 would have been written into the second storage device 124 prior to execution of the update processing, is calculated. Then, when the estimated free space SCe is smaller than the volume CSd of the other new software 202, i.e., the space required to write the other new software 202 into the second storage device 124, the other new software 202 is inhibited from being written into the second storage device 124, so that it is possible to avoid a situation in which the current software 92 cannot be backed up in the second storage device 124 when the update processing using the already written new software 202 is to be executed.

In the present embodiment, the update processing is executed when the control of the vehicle 10 by using the current software 92 that is to be updated to the new software 202 is not being executed, so that it is possible to prevent problem from being caused in execution of the control of the vehicle 10, due to execution of the update processing of the current software 92.

While the preferred embodiment of this invention has been described in detail by reference to the drawings, it is to be understood that the invention may be otherwise embodied.

In the above-described embodiment, at least the first storage device 91, vehicle-control execution portion 97, state determining portion 98 and backup processing portion 99 are included in the electronic control device 90 as the first control device, while at least the update processing portion 122, second storage device 124 and reception processing portion 128 are included in the update control device 120 as the second control device. However, this arrangement is not essential. For example, an entirety or a part of the backup processing portion 99 may be included in the update control device 120. Further, an entirety or a part of the reception processing portion 128 may be included in the electronic control device 90. That is, the construction of the vehicle control apparatus 150 may be modified as needed, as long as at least the first and second storage devices 91, 124 are included in the electronic control device 90 and update control device 120, respectively, and at least the vehicle-control execution portion 97, state determining portion 98, backup processing portion 99, update processing portion 122 and reception processing portion 128 are included in the vehicle control apparatus 150.

In the above-described embodiment, the update processing of the vehicle control software 92 is executed with the use of the new software 202 that is received from the server 200 through the wireless communication R. However, this arrangement is not essential. For example, also in a case (hereinafter referred to as first case) in which the update processing of the vehicle control software 92 is executed with use of the external rewriting device 210, or in a case (hereinafter referred to as second case) in which the update processing of the vehicle control software 92 is executed with use of a new software read out from a recording medium (having the new software stored therein) such as an optical disc (e.g., CD, DVD) and a non-volatile memory (e.g., flash memory) through a reading device provided in the vehicle 10, for example, in a vehicle storage that is not located in a site of a vehicle dealer or other vehicle expert, there is a risk that the control of the vehicle 10 with use with the updated vehicle control software 92 could not be made in the event of failure of the update processing without availability of support service from the expert. Therefore, in each of the above-described first and second cases in which the update processing of the vehicle control software 92 is executed with use of the external rewriting device 210 or with use of the new software read out from the recording medium through the reading device provided in the vehicle 10, too, it is possible to execute the above-described control routine shown in the flow chart of FIG. 8. It is noted that, in each of the above-described first and second cases, step S10 of the control routine of FIG. 8 is implemented to determine whether there is a request for writing from the external rewriting device 210 or the reading device of the vehicle 10, namely, a request requesting the new software 202 to be received from the external rewriting device 210 or the reading device of the vehicle 10 and to be written into the second storage device 124. Further, in the above-described first case, the new software, which has been stored in the external rewriting device 210 and to which the vehicle control software 92 is to be updated, is transmitted to the second storage device 124 of the update control device 120 through the second gateway ECU 130 and is stored as the received new software 126 in the second storage device 124. Similarly, in the above-described second case, the new software, which has been stored in the recording medium and to which the vehicle control software 92 is to be updated, is transmitted to the second storage device 124 of the update control device 120 through the reading device of the vehicle 10 and is stored as the received new software 126 in the second storage device 124. The second storage device 124 is a storage device configured to store therein the new software to which the vehicle control software 92 is to be updated. The writing of the new software into the second storage device 124 may be made through any communication manner such as a wireless manner, a wired manner and a manner using the reading device of the vehicle 10.

In the above-described embodiment, in a state in which the received new software 126 is already stored in the second storage device 124, the reception of the other new software 202 (that is other than the received new software 126) from the server 200 may be always inhibited. In this arrangement, in the control routine shown in FIG. 8, steps S10 through S40 do not necessarily have to be provided. It is noted that the other new software other than the received new software 126 does not necessarily have to be the new software 202 to which the vehicle new software 202 is to be updated, but may be a new software that is to be written into the first storage device 91 for adding a function to the vehicle control apparatus 150.

In the above-described embodiment, the transceiver 100 and the server 200 are connected to each other through the network 220. However, the transceiver 100 and the server 200 may be connected to each other, for example, a wireless device provided in the server 200, or a wireless device connected directly to the server 200.

In the above-described embodiment, the vehicle 10 provided with the transmission device 40 constitutes a vehicle to which the present invention is applied. However, the present invention is applicable not only to the vehicle 10 but also to any kind of vehicle in which the update processing of the vehicle control software is to be executed.

It is to be understood that the embodiment described above is given for illustrative purpose only, and that the present invention may be embodied with various modifications and improvements which may occur to those skilled in the art.

### NOMENCLATURE OF ELEMENTS

10: vehicle
90: electronic control device (first control device)
91: first storage device
92: vehicle control software
97: vehicle-control execution portion
99: backup processing portion
120: update control device (second control device)
122: update processing portion
124: second storage device
128: reception processing portion
150: vehicle control apparatus
202: new software

What is claimed is:

1. A control apparatus provided with first and second control devices, and configured to execute vehicle control for controlling a vehicle and to execute update processing for updating a vehicle control software that is to be used for the vehicle control,
the control apparatus comprising:
a first storage device included in the first control device and configured to store therein the vehicle control software;
a second storage device included in the second control device and configured to store therein a new software to which the vehicle control software is to be updated by execution of the update processing;
a vehicle-control execution portion configured to execute the vehicle control by using the vehicle control software;
an update processing portion configured to execute the update processing for updating the vehicle control software by writing the new software stored in the second storage device, into the first storage device; and
a backup processing portion configured, prior to the update processing by the update processing portion, to write the vehicle control software stored in the first storage device, into the second storage device.

2. The control apparatus according to claim 1,
wherein the backup processing portion is configured, when the update processing has not been successfully executed by the update processing portion, to write the vehicle control software written into the second storage device, into the first storage device.

3. The control apparatus according to claim 1,
wherein the backup processing portion is configured, when the update processing has been successfully executed by the update processing portion, to erase the vehicle control software written into the second storage device, from the second storage device.

4. The control apparatus according to claim 1, further comprising a reception processing portion configured, when the second storage device is to store therein another new software other than the new software that has been already written into the second storage device and stored in the second storage device, to calculate an estimated free space left in the second storage device in a state in which the vehicle control software has been written into the second storage device by the backup processing portion prior to execution of the update processing by the update processing portion,
wherein the reception processing portion is configured, when the estimated free space is smaller than a space required to write the other new software into the second storage device, to inhibit the other new software from being written into the second storage device.

5. The control apparatus according to claim 1,
wherein the update processing portion is configured to execute the update processing when the vehicle-control execution portion does not execute the vehicle control by using the vehicle control software that is to be updated to the new software.
